(19) United States
(12) Patent Application Publication
(10) Pub. No.: US 2021/0235231 A1
(43) Pub. Date: Jul. 29, 2021

(54) Systems and Methods for Locating an Asset

(71) Applicant: Payton Hamilton, DPO, AE (US)

(72) Inventor: Payton Hamilton, Frankfurt (DE)

(21) Appl. No.: 17/198,920

(22) Filed: Mar. 11, 2021

(51) Int. Cl. H04W 4/029

(52) U.S. Cl. CPC H04W 4/029

(57) ABSTRACT

Utilizing both WiFi™ connection capabilities and RFID tracking chips found in everyday electronics, this patent outline a system for locating assets. The process uses a series of protocols to determine where the lost asset is not located based on transmitted signals of other known, fixed assets. As signals emit from known assets overlap, it is possible to determine where the lost asset is in relation to these known assets. Furthermore, when the use of a mobile asset's signal is combined with the physical movement of the user, the lost asset can be even more efficiently retrieved.

### BACKGROUND OF THE INVENTION

Various embodiments provide systems and/or methods for locating assets, and more particularly for using wireless interactions to locate an asset.

It is a common occurrence to misplace an asset, such as, for example, a cellular telephone. In some cases, the sound of the cellular telephone is turned off such that placing a call to the misplaced cellular telephone does not result in a sound making it difficult to find the cellular telephone. Further, the problem of being misplaced increases as the battery of the cellular telephone is exhausted rendering the cellular telephone inoperable.

Thus, for at least the aforementioned reasons, there exists a need in the art for advanced approaches, devices, and systems for locating assets.

### BRIEF SUMMARY OF THE INVENTION

Various embodiments provide systems and/or methods for locating assets, and more particularly for using wireless interactions to locate an asset.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a system including a movable device and an asset, where the system usable to identify a location of the movable device in accordance with various embodiments;

FIG. 2 is a flow diagram showing a method for detecting an asset location in accordance with some embodiments;

FIG. 3 shows a system including a movable device, a movable asset, a first fixed asset, and a second fixed asset; and

FIG. 4 shows an example relative deployment of mobile device, a movable asset, a first fixed asset, and a second fixed asset in accordance with one embodiment.

### DETAILED DESCRIPTION OF THE INVENTION

Various embodiments provide systems and/or methods for automated maintenance, delivery, retrieval, and/or communications using drones.

In some embodiments, a method for locating a movable asset is disclosed that includes: providing a movable device having a first communication circuit of a first wireless communication type and a second communication circuit of a second wireless communication type; moving the movable device; as the movable device moves, determining communication between a third wireless communication circuit of the first type in the movable asset and the first communication circuit, and determining communication between a fourth communication circuit of the second wireless communication type in the movable asset and the second communication circuit; and displaying a range of possible locations of the movable asset based upon both the determination of communication between a third wireless communication circuit of the first type in the movable asset and the first communication circuit and the determination of communication between a fourth communication circuit of the second wireless communication type in the movable asset and the second communication circuit.

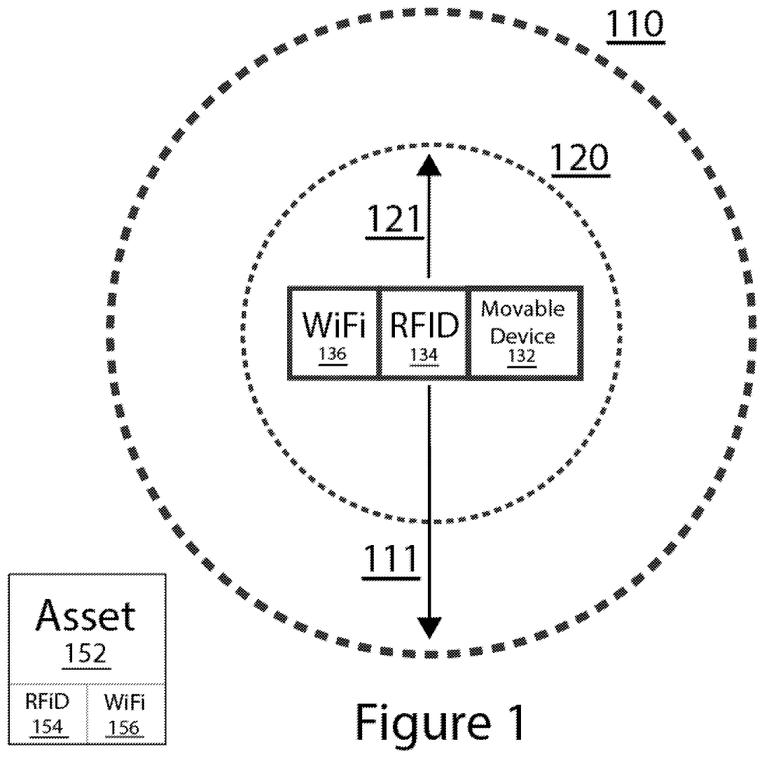

Turning to FIG. 1, a system 100 is shown that includes an asset 152 and a movable device 132. Asset 152 includes at least two wireless communication circuits each capable of communicating a different distances. In the embodiment shown, the two wireless communication circuits are a wireless local area network (WiFi™) communication circuit 156 and a radio-frequency identification (RFID) circuit 154. WiFi™ communication circuit 156 allows for wireless communication up to a first distance 111 from asset 152, and RFID communication circuit 154 allows for wireless communication up to a second distance 121 form asset 152. In one particular embodiment, asset 152 is a cellular telephone. Based upon the disclosure provided herein, one of ordinary skill in the art will recognize a variety of asset types that include at least two wireless communication circuits including, but not limited to, watches, laptop computers, medical devices, and the like.

Movable device 132 includes at least two wireless communication circuit that correspond to the wireless communication circuits of asset 152. Similar to that discussed in relation to asset 152, each of the wireless communication circuits is capable of communicating up to a distance different from movable device 132. In the embodiment shown, the two wireless communication circuits are a WiFi™ communication circuit 136 and a radio-frequency identification (RFID) circuit 134. WiFi™ communication circuit 136 allows for wireless communication up to a first distance 111 from movable device 132, and RFID communication circuit 134 allows for wireless communication up to a second distance 121 form movable device 132. In one particular embodiment, movable device 132 is a cellular telephone. Based upon the disclosure provided herein, one of ordinary skill in the art will recognize a variety of movable device types that include at least two wireless communication circuits including, but not limited to, watches, laptop computers, medical devices, and the like.

In operation, movable device 132 is moved to different locations relative to asset 152. As movable device 132 is moved, software executing on a processor included in movable device 132 seeks to detect WiFi™ communications emanating from WiFi™ communication circuit 156 of asset 152 and/or RFID communications emanating from RFID communication circuit 154 of asset 152. The results of the aforementioned seeking process may be displayed on a display included on movable device 132. Thus, when an individual moving movable device 132 can discern that they are getting closer to asset 152 when communications emanating from WiFi™ communication circuit 156, and can continue moving a similar direction until communications emanating from RFID communication circuit 154.

The aforementioned seeking process narrows the probable location of asset 132 in accordance with the following pseudocode:

```
If (WiFi ™ detected and RFID detected){
  Asset 132 is within distance 121 of Movable Device 152}
Else If (WiFi ™ detected and RFID not detected){
  Asset 132 is within distance 111 of Movable Device 152}
Else {
  Asset 132 is more than distance 121 from Movable Device 152}
```

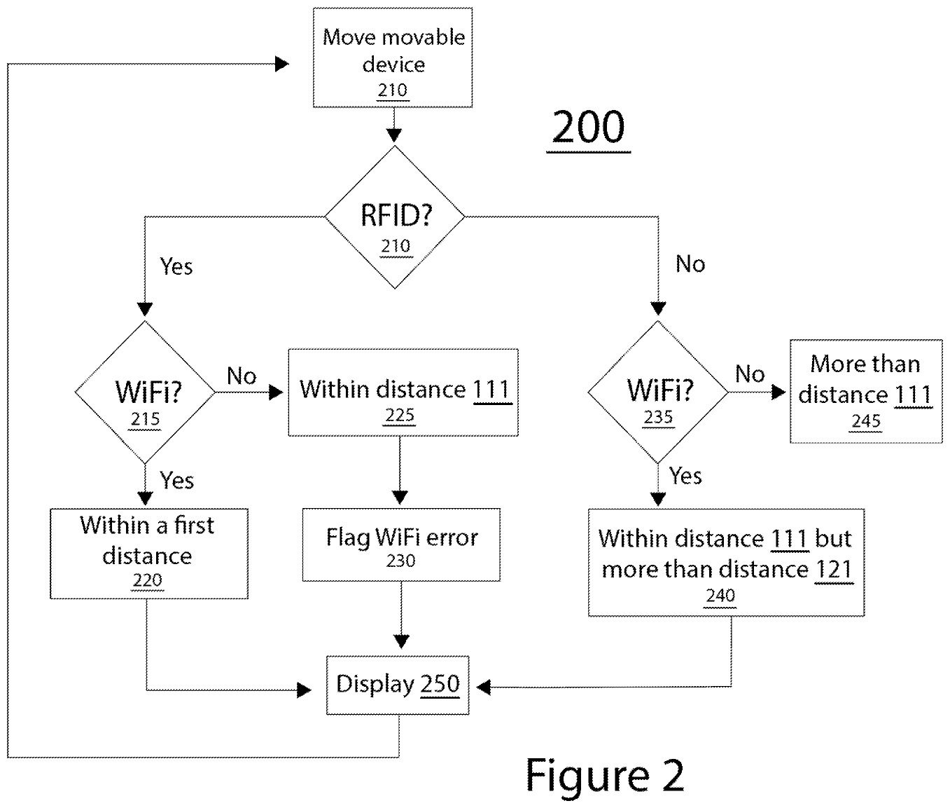

Turning to FIG. 2, a flow diagram 200 shows a method for detecting an asset location. Following flow diagram 200, a movable device is moved (block 205). The movable device determines whether RFID communications are detected emanating from an asset (block 210). Where RFID communications emanating from the asset are detected (block 210), the movable device determines whether WiFi™ communications are detected emanating from the asset (block 215). Where WiFi™ communications are detected emanating from the asset (block 215), then the movable device is within a first distance (e.g., distance 121)(block 220). Alternatively, where WiFi™ communications are not detected emanating from the asset (block 215), then the movable device is within a second distance (e.g., distance 111)(block 225) and a WiFi™ error is flagged (block 230).

Alternatively, where RFID communications are not detected emanating from the asset (block 210), the movable device determines whether WiFi™ communications are detected emanating from the asset (block 235). Where WiFi™ communications are detected emanating from the asset (block 235), then the movable device is within the second distance from asset 132 (e.g., distance 111), but greater than the first distance (e.g., distance 121)(block 220). Alternatively, where WiFi™ communications are not detected emanating from the asset (block 235), then the movable device is more than the second distance from asset 132 (e.g., distance 111). The results are updated to a display on the movable device (block 250), and the process is started anew as the movable device is moved to a new location (block 205).

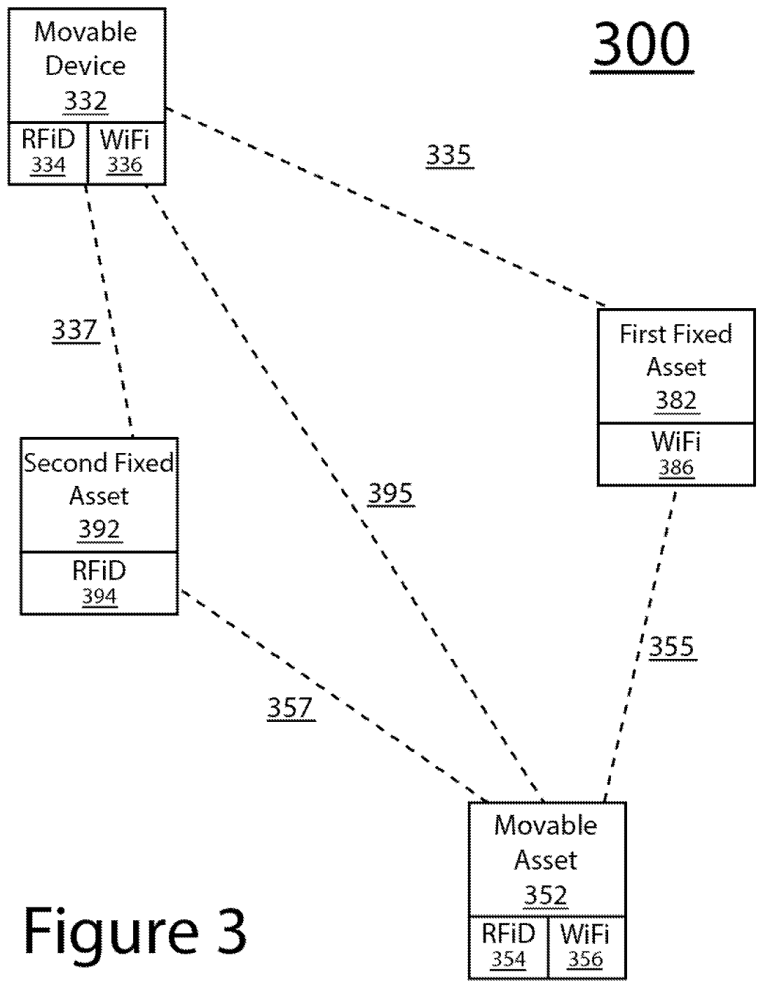

Turning to FIG. 3, a system 300 is shown that includes a movable device 332, an asset 352, a first fixed asset 382, and a second fixed asset 392. Asset 352 includes at least two wireless communication circuits each capable of communicating a different distances. In the embodiment shown, the two wireless communication circuits are a WiFi™ communication circuit 356 and an RFID circuit 354. WiFi™ communication circuit 356 allows for wireless communication up to a first distance from asset 352, and RFID communication circuit 354 allows for wireless communication up to a second distance from asset 352. In one particular embodiment, asset 352 is a cellular telephone. Based upon the disclosure provided herein, one of ordinary skill in the art will recognize a variety of asset types that include at least two wireless communication circuits including, but not limited to, watches, laptop computers, medical devices, and the like.

Movable device 332 includes at least two wireless communication circuits that correspond to the wireless communication circuits of asset 352. Similar to that discussed in relation to asset 352, each of the wireless communication circuits is capable of communicating up to a distance different from movable device 332. In the embodiment shown, the two wireless communication circuits are a WiFi™ communication circuit 336 and a radio-frequency identification (RFID) circuit 334. WiFi™ communication circuit 336 allows for wireless communication up to a first distance 111 from movable device 132, and RFID communication circuit 134 allows for wireless communication up to a second distance 121 form movable device 132. In one particular embodiment, movable device 132 is a cellular telephone. Based upon the disclosure provided herein, one of ordinary skill in the art will recognize a variety of movable device types that include at least two wireless communication circuits including, but not limited to, watches, laptop computers, medical devices, and the like.

First fixed asset 382 is installed at a known first location and is not movable. First fixed asset 382 includes a first wireless communication circuit that corresponds to one of the wireless communication circuits in either or both of movable device 332 and/or asset 352. In this particular embodiment, first fixed asset 382 includes a WiFi™ communication circuit 386. Second fixed asset 392 is installed at a known second location and is not movable. Second fixed asset 392 includes a second wireless communication circuit that corresponds to one of the wireless communication circuits in either or both of movable device 332 and/or asset 352. In this particular embodiment, second fixed asset 392 includes a WiFi™ communication circuit 386. In some embodiments, first fixed asset 382 is a WiFi™ router, and second fixed asset 392 is an RFID reader. Based upon the disclosure provided herein, one of ordinary skill in the art will recognize a variety of devices that may be used as first fixed asset 382 and/or second fixed asset 392.

When within range of first fixed asset 382, asset 352 receives a signal 355 emanating from first fixed asset 382 (e.g., WiFi™ range). Similarly, when within range of first fixed asset 382 (e.g., WiFi™ range), movable device 332 receives a signal 335 emanating from first fixed asset 382. When within range (e.g., RFID range) of second fixed asset 392, asset 352 receives a signal 357 emanating from second fixed asset 392. Similarly, when within range of second fixed asset 392 (e.g., RFID range), movable device 332 receives a signal 337 emanating from second fixed asset 392.

In operation, once movable device 352 is within a distance of a signal emanating from WiFi™ circuit 356 of asset 352, asset 352 transmits a signal 395 to movable device 332 indicating which, if any, of first fixed asset 382 and/or second fixed asset 392 that asset 352 can detect. As movable device 352 is moved around relative to asset 332, it detects different ones of first fixed asset 382, second fixed asset 392, and/or asset 332.

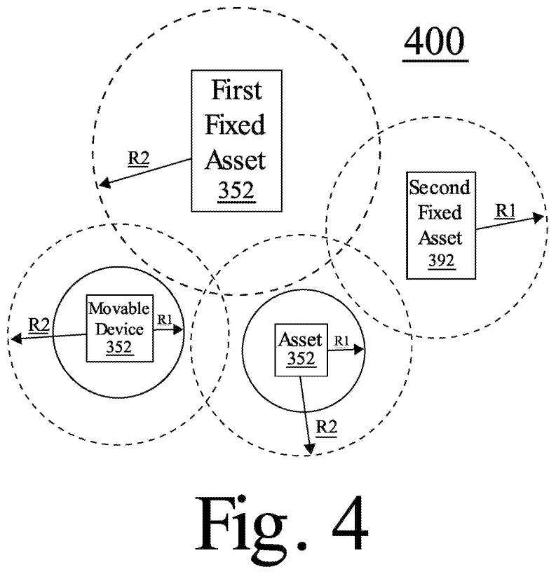

Turning to FIG. 4, an example relative deployment of mobile device 352, asset 332, first fixed asset 382, and second fixed asset 392 is shown. R2 is a WiFi™ range radius, and R1 is an RFID range radius. As shown in this example, mobile device 352 is within R2 range of first fixed asset 382, within R2 range of asset 332, and not in range of second fixed asset 392. Asset 332 is within R2 range of first fixed asset 382, and not within range of second fixed asset 392 (to be within range, asset 332 would need to be within R1 range of second fixed asset 392 as only RFID communication is supported by second fixed asset 392). In such a situation, asset 332 communicates via WiFi™ that it is within R2 range of first fixed asset 382, and not within range of second fixed asset 392. This information can be used in accordance with the following pseudocode to determine the location of asset 332:

```
  If (No WiFi Connection between Movable Device 352 and Asset
  332){
    Asset 332 is more than a distance R2 from Movable Device 352}
  Else If (WiFi Connection between Movable Device 352 and Asset
  332){
    If (Asset 332 Connected to: First Fixed Asset 382 and Second
Fixed Asset 392 and RFID Circuit 354){
      If (Movable Device 352 Connected to: Second Fixed Asset
      392){
        Asset 332 is within R1 range of Movable Device 352 and
R1 range of Second Fixed Asset 392}
      Else {
        Asset 332 is within R1 range of Second Fixed Asset 392, and
located between movable device 352 and second fixed asset 392}
    Else If (Asset 332 Connected to: First Fixed Asset 382, but not
RFID circuit 354 or second fixed asset 392){
      If (Movable Device 352 Connected to: First Fixed Asset 382){
        Asset 332 is within R2 range of Movable Device 352, within
R2 Range of First Fixed Asset 382, more than R1 Range from second
Fixed Asset 392, and more than R1 Range of Movable Device 352}
      Else {
        Asset 332 is within R1 range of Movable Device 352,
within R2 Range of First Fixed Asset 382, more than R1 Range
from second Fixed Asset 392, and Asset 332 is located in a direction
between Movable Device 352 and First Fixed Asset 382}
}
```

In conclusion, the present inventions provide for novel systems, devices, and methods for monitoring individuals and/or assets. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for locating a movable asset, the method comprising:
providing a movable device having a first communication circuit of a first wireless communication type and a second communication circuit of a second wireless communication type;
moving the movable device;
as the movable device moves, determining communication between a third wireless communication circuit of the first type in the movable asset and the first communication circuit, and determining communication between a fourth communication circuit of the second wireless communication type in the movable asset and the second communication circuit; and
displaying a range of possible locations of the movable asset based upon both the determination of communication between a third wireless communication circuit of the first type in the movable asset and the first communication circuit and the determination of communication between a fourth communication circuit of the second wireless communication type in the movable asset and the second communication circuit.
